(19) United States
(12) Patent Application Publication
(10) Pub. No.: US 2020/0070329 A1
(43) Pub. Date: Mar. 5, 2020

(54) PRESSING TOOL

(71) Applicant: TECHTRONIC CORDLESS GP, Anderson, SC (US)

(72) Inventors: William C. Buck, Clemson, SC (US); Todd E. Woodhams, Anderson, SC (US); Julia H. Moylan, Anderson, SC (US); Brent N. Gregorich, Easley, SC (US)

(21) Appl. No.: 16/554,828

(22) Filed: Aug. 29, 2019

Related U.S. Application Data
(60) Provisional application No. 62/725,317, filed on Aug. 31, 2018.

(51) Int. Cl. B25B 27/14

(52) U.S. Cl. CPC B25B 27/146

(57) ABSTRACT

A pressing tool includes a housing, first and second jaws at least partially disposed in the housing, the first and second jaws being pivotal respective to a portion of the housing, a motor supported within the housing, an output shaft driven by the motor, the output shaft including a threaded portion, and a roller carriage including a threaded bore in which the output shaft is received such that rotation of the output shaft advances or retracts the roller carriage to pivot the jaws.

### CROSS-REFERENCE TO RELATED APPLICATIONS

This application claims priority to co-pending U.S. Provisional Patent Application No. 62/725,317, filed on Aug. 31, 2018, the entire content of which is incorporated herein by reference.

### FIELD

The present subject matter relates to pressing tools, and more particularly to mechanical pressing tools, such as crimping and clamping tools.

### BACKGROUND

Cross-linked polyethylene tubing, commonly abbreviated as PEX or XLPE, is often used for domestic water piping to replace traditional copper piping. PEX tubing is typically attached to fittings using compression rings. In its nominal (uncompressed) state, a compression ring can be slid over the PEX tubing and fitting, then compressed using a pressing tool to clamp the PEX tubing to the fitting. Manual pressing tools, including clamping tools for use with clamp rings and crimping tools for use with crimp rings, typically including a pair of handles coupled to pressing jaws by a pivoting linkage arrangement.

### SUMMARY

The present subject matter provides, in one aspect, a pressing tool including a housing, first and second jaws at least partially disposed in the housing, the first and second jaws being pivotal respective to a portion of the housing, a motor supported within the housing, an output shaft driven by the motor, the output shaft including a threaded portion, and a roller carriage including a threaded bore in which the output shaft is received such that rotation of the output shaft advances or retracts the roller carriage to pivot the jaws.

In some embodiments, the first and second jaws include a clamping tip configured to compress a PEX clamp ring.

In some embodiments, the first and second jaws include a crimping die configured to compress a PEX crimp ring.

In some embodiments, the housing includes a generally cylindrical handle portion defining a longitudinal axis. The handle portion is configured to be gripped by a user during operation of the pressing tool, and the output shaft extends coaxial with the longitudinal axis.

In some embodiments, the housing includes a battery support portion adjacent the handle portion, and the pressing tool also includes a battery removably coupled to the battery support portion to provide power to the motor.

In some embodiments, the battery support portion includes a receptacle, and the battery includes a stem insertable into the receptacle along a battery axis parallel to the longitudinal axis.

In some embodiments, the pressing tool also includes a transmission coupled between the motor and the output shaft, and a gear case in which the transmission is at least partially disposed.

In some embodiments, the gear case is disposed within the handle portion of the housing.

In some embodiments, the output shaft is axially fixed relative to the transmission.

In some embodiments, the output shaft includes a flange, and the pressing tool also includes a thrust bearing disposed between the gear case and the flange.

The present subject matter provides, in another aspect, a pressing tool including a housing, first and second jaws extending from the housing, the first and second jaws being pivotal respective to a portion of the housing, a motor supported within the housing, a transmission coupled to the motor, the transmission at least partially disposed within a gear case, and an output shaft coupled to the transmission. The output shaft is supported within the housing for rotation about a longitudinal axis, and the output shaft is axially fixed relative to the gear case. The pressing tool also includes a roller carriage in direct threaded engagement with the output shaft such that rotation of the output shaft advances or retracts the roller carriage to pivot the jaws.

In some embodiments, the first and second jaws include one of a clamping tip or a crimping die.

In some embodiments, one or more magnets are disposed in the roller carriage.

In some embodiments, the pressing tool includes a microcontroller configured to control operation of the motor.

The present subject matter provides, in another aspect, a clamping tool including a housing, and first and second jaws extending from a portion of the housing, the first and second jaws including an arm, a cam surface on an inner side of the arm, and a clamping tip. The jaws are pivotable between a closed position and an open position for compressing a clamp ring. The clamping tool also includes a motor supported within the housing, an output shaft driven by the motor, and a roller carriage supporting first and second rollers. The roller carriage is coupled to the output shaft such that rotation of the output shaft in a first direction advances the roller carriage to move the jaws toward the closed position, and rotation of the output shaft in a second direction retracts the roller carriage, allowing the jaws to move toward the open position. The first and second rollers engage the cam surfaces the respective first and second jaws when in the open position.

In some embodiments, the roller carriage is in direct threaded engagement with the output shaft.

In some embodiments, the housing includes a handle portion defining a longitudinal axis and a battery support portion adjacent the handle portion, and the clamping tool also includes a battery removably coupled to the battery support portion to provide power to the motor.

In some embodiments, the battery support portion includes a receptacle, and the battery includes a stem insertable into the receptacle along a battery axis parallel to the longitudinal axis.

In some embodiments, the clamping tool also includes a transmission coupled between the motor and the output shaft, and a gear case in which the transmission is at least partially disposed.

In some embodiments, the gear case is disposed within the handle portion of the housing.

In some embodiments, the output shaft is axially fixed relative to the transmission.

Other features and aspects of the present subject matter will become apparent by consideration of the following detailed description and accompanying drawings.

### BRIEF DESCRIPTION OF THE DRAWINGS

FIG. 1A is a perspective view illustrating a clamp ring in an uncompressed state.

FIG. 1B is a perspective view illustrating the clamp ring of FIG. 1A in a compressed state.

FIG. 2A is a perspective view illustrating a crimp ring in an uncompressed state.

FIGS. 2B and 2C are perspective views illustrating the crimp ring of FIG. 2A in a compressed state.

FIG. 3 is a side view of a clamping tool according to an embodiment of the present subject matter.

FIG. 4 is a perspective view illustrating a portion of the clamping tool of FIG. 3.

FIG. 5 is a cross-sectional view of the clamping tool of FIG. 3, with jaws of the clamping tool in an open position.

FIG. 6 is a cross-sectional view of the clamping tool of FIG. 3, with the jaws of the clamping tool in a closed position.

FIG. 7 is a cross-sectional view of a crimping tool according to another embodiment of the present subject matter, with jaws of the crimping tool in an open position.

FIG. 8 is a cross-sectional view of the crimping tool of FIG. 7, with the jaws in a closed position.

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways. Also, it is to be understood that the phraseology and terminology used herein is for the purpose of description and should not be regarded as limiting.

### DETAILED DESCRIPTION

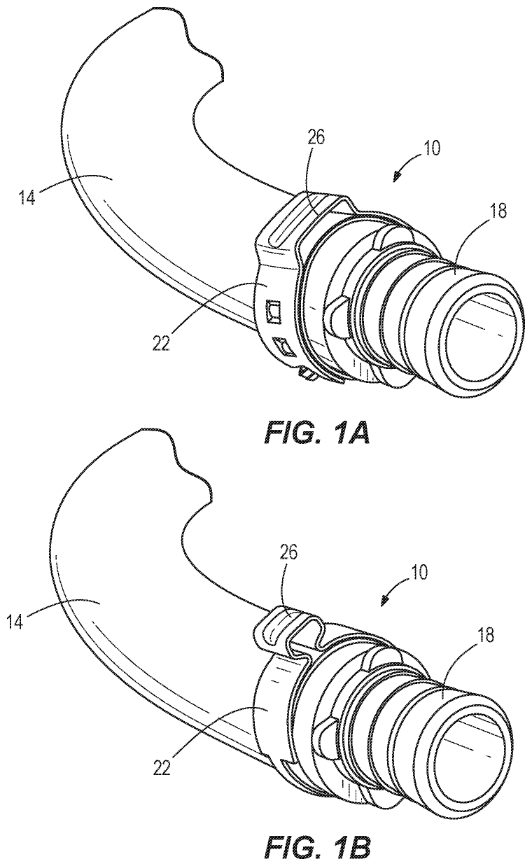

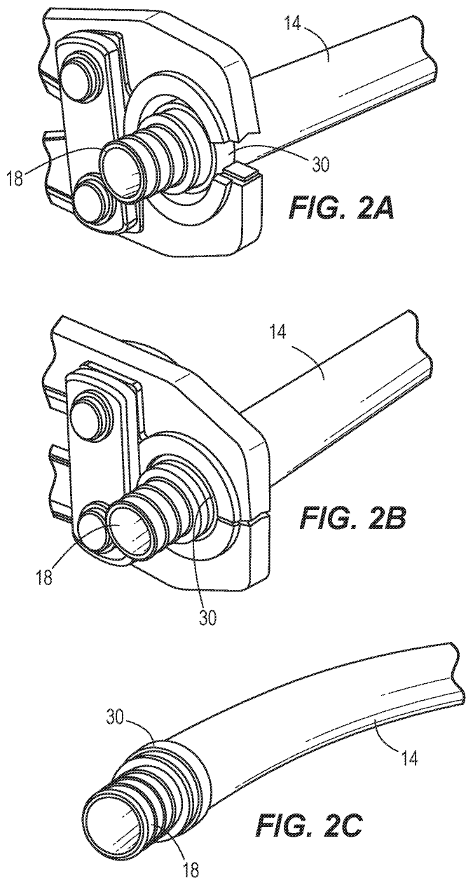

A clamp ring 10, illustrated in FIGS. 1A-1B, is one type of compression ring that can be used to attach PEX tubing 14 to a fitting 18. Clamp rings 10 are typically made of stainless steel and include an outer band 22 with an integral tab 26. In use, the tab 26 is deformed inwardly to reduce the diameter of the outer band 22 and thereby clamp the PEX tubing 14 to the fitting 18. Another type of compression ring that can be used to attach PEX tubing 14 to a fitting 18 is a crimp ring 30, illustrated in FIGS. 2A-2C. A crimp ring 30 is a continuous ring that is typically made of copper. In use, the crimp ring 30 is compressed on all sides to reduce its diameter (FIG. 2B) and thereby crimp and/or clamp the PEX tubing 14 to the fitting 18 (FIG. 2C).

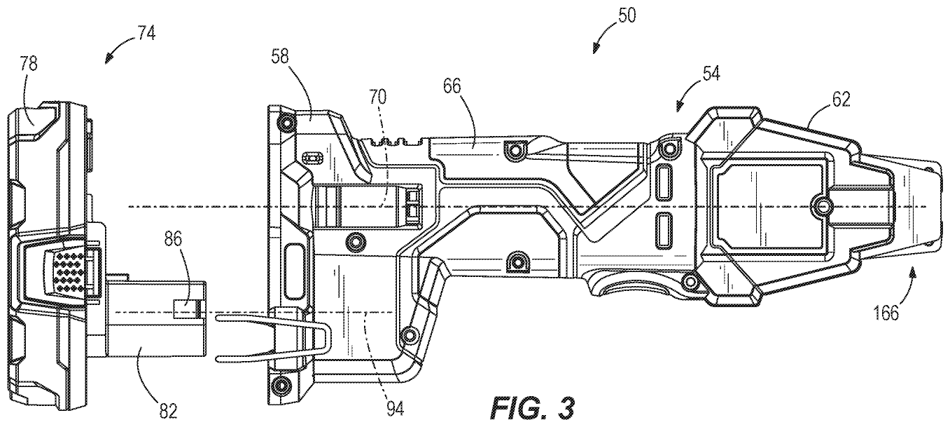

FIG. 3 illustrates a pressing tool 50, which is a PEX clamping tool 50 in the illustrated embodiment. The clamping tool 50 includes a housing 54 having a battery support portion 58, a head portion 62, and a handle portion 66 configured to be gripped by a user during operation of the clamping tool 50. In the illustrated embodiment, the handle portion 66 is generally cylindrical or barrel-shaped and defines a longitudinal axis 70 extending centrally through the handle portion 66. The handle portion 66 may be positioned between the battery support portion 58 and the head portion 62, such that the PEX clamping tool 50 has an in-line configuration. In other words, the battery support portion 58, the handle portion 66, and the head portion 62 may be arranged in series along the longitudinal axis 70. The in-line arrangement of the clamping tool 50 advantageously provides the clamping tool 50 with a relatively compact shape and size, increasing its usability in tight spaces. In other embodiments, however, the handle portion 66 may extend at an angle relative to the head portion 62 (e.g., a 90-degree angle) to provide the pressing tool 50 with a pistol grip arrangement.

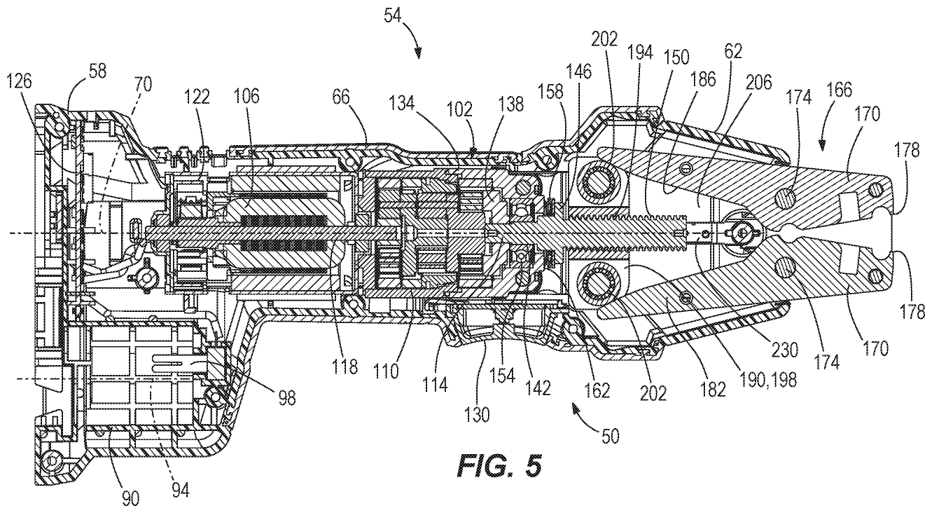

The battery support portion 58 is configured to support a battery 74 that includes a battery housing 78 enclosing an array of battery cells (e.g., lithium-based rechargeable cells, not shown). A stem 82 may extend from the battery housing 78 (e.g., along a direction parallel to the longitudinal axis 70) and include electrically conductive contacts 86 that are electrically connected to the battery cells. Where provided, the stem 82 is insertable into a receptacle 90 (FIG. 5) in the battery support portion 58 of the housing 54 along a battery insertion axis 94. In the illustrated embodiment, the battery insertion axis 94 is parallel to the longitudinal axis 70. In some embodiments, the battery insertion axis 94 may be coaxial with the longitudinal axis 70, perpendicular to the longitudinal axis 70, obliquely oriented with respect to the longitudinal axis 70, and/or the like. In some embodiments, the battery 74 may be devoid of a stem 82 and be formed as a slide pack. The receptacle 90 includes electrically conductive contacts 98 that engage the contacts 86 on the battery 74 (FIG. 3), for example, when the battery 74 (e.g., the stem 82) is inserted, slid, or otherwise contacts the receptacle 90 to transmit power from the battery 74 to the clamping tool 50.

Referring to FIG. 5, the clamping tool 50 has a drive assembly 102 including a motor 106, a transmission 110, and an output shaft 114. In the illustrated embodiment, the motor 106 is a brushed DC electric motor 106 having a motor shaft 118 that is coaxial with the longitudinal axis 70. In some embodiments, the motor 106 may be a brushless motor or any other suitable electric motor. The motor shaft 118 provides a rotational input to the transmission 110 at one end, and an opposite end of the motor shaft 118 is coupled to a fan 122. In the illustrated embodiment, the fan 122 overlaps the battery receptacle 90 in a direction parallel to the longitudinal axis 70. In other words, a plane can be drawn transverse to the longitudinal axis 70 that intersects both the fan 122 and the battery receptacle 90. This arrangement allows the overall length of the clamping tool 50 along the longitudinal axis 70 to be shortened. In this way, the clamping tool 50 may be more easily maneuvered and/or handled during use.

A printed circuit board or PCB 126 is located within the battery support portion 58 of the housing 54. The PCB 126 may include a suitable controller (e.g., a microcontroller such as a microprocessor), switching electronics (e.g., MOSFETs, IGBTs, or the like), and other components for controlling the operation of the motor 106, controlling the delivery of power from the battery 74 to the motor 106, obtaining signals from sensors (e.g., Hall effect sensors, and/or the like) and/or switches, controlling the motor 106 based on the signals obtained from the sensors and/or switches, and/or the like. A switch 130 for energizing the motor 106 and, in some embodiments, for controlling a rotational direction and/or operating speed of the motor 106, is located on the handle portion 66 of the housing 54. The switch 130 may be configured as a trigger, push-button, rotary dial, and/or the like.

With continued reference to FIG. 5, the transmission 110 is at least partially housed within a transmission housing or gear case 134 located within the handle portion 66. In the illustrated embodiment, the transmission 110 includes a planetary transmission 110 having three planetary stages, though any number of planetary stages (e.g., less than three, more than three, and/or the like) may be used. The transmission 110 includes a last stage carrier 138 (i.e. the carrier of the third planetary stage) that provides a rotational output from the transmission 110. The last stage carrier 138 may be coupled to the output shaft 114, which may extend into the head portion 62 of the housing 54. In some embodiments, the drive assembly 102 may include other types of transmissions, gear reductions, or the like; or, the output shaft 114 may be directly driven by the motor 106.

In the illustrated embodiment, the output shaft 114 may extend coaxially with the longitudinal axis 70. The output shaft 114 includes a bearing seat 142, a radially-extending flange 146, and a threaded portion 150. The flange 146 may be positioned between the bearing seat 142 and the threaded portion 150. A roller bearing 154 may be fixed to the bearing seat 142 to rotatably support the output shaft 114 in the housing 54. The drive assembly 102 may further include a thrust bearing 158 disposed axially between the flange 146 and a front wall 162 of the gear case 134. The output shaft 114, thus, may be axially fixed relative to the gear case 134.

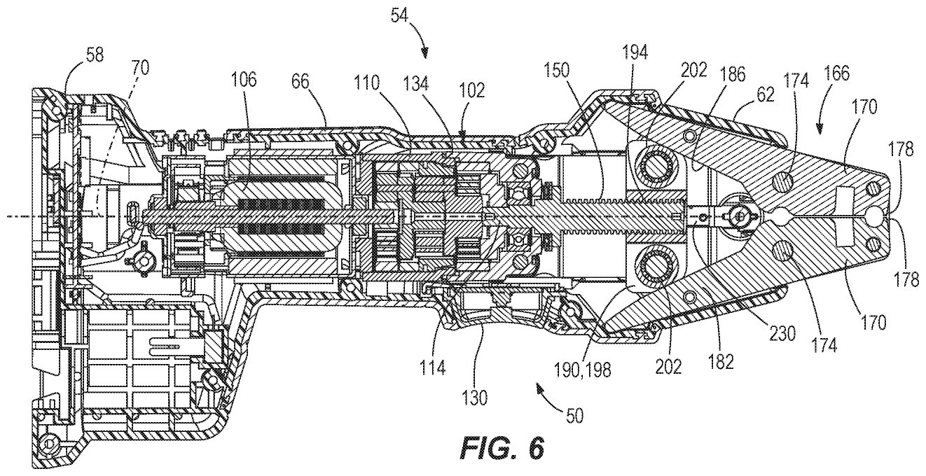

The head portion 62 of the housing 54 is configured to support a working assembly 166 that includes a pair of jaws 170. The jaws 170 are pivotable about respective parallel pins 174 between an open position (FIG. 5) and a closed position (FIG. 6). Each of the jaws 170 may include a distal clamping tip 178 and a proximal arm 182 located on opposite sides of the pin 174. The clamping tips 178 are sized and shaped to engage with clamp rings, such as the clamp ring 10 described above with reference to FIGS. 1A and 1B, and/or the like. In some embodiments, dies with other configurations are pivotably coupled to the housing 54 (e.g., in part via the pins 174). For example, the clamping tips 178 may be replaced with a semi-circular dies or other dies, as desired. Each of the arms 182 may include a cam surface 186. The jaws 170 may be biased toward the open position by a biasing member (not shown), such as a coil spring or a torsion spring. Alternatively, the jaws 170 may be biased toward the closed position, or the jaws 170 may not be spring-biased.

The drive assembly 102 may additionally include a roller carriage 190 coupled to the threaded portion 150 of the output shaft 114. More specifically, the roller carriage 190 includes a threaded bore 194 through which the threaded portion 150 of the output shaft 114 extends, such that rotation of the output shaft 114 relative to the roller carriage 190 advances or retracts the roller carriage 190 along the output shaft 114 (and thus, along the longitudinal axis 70). In the illustrated embodiment, the threaded portion 150 of the output shaft 114 and the threaded bore 194 of the roller carriage 190 may each include a trapezoidal or Acme thread configuration. The Acme thread configuration is particularly suitable due to its high strength (e.g., the Acme thread configuration is configured to withstand the large axial loads between the output shaft 114 and roller carriage 190 that occur during operation). The Acme thread configuration is also relatively simpler and less costly to manufacture than other thread forms, such as square threads. In some embodiments, however, other thread forms may be used, such as metric, unified, stub, and/or the like.

The roller carriage 190 may include a main body 198 that rotatably supports two rollers 202, bushings, and/or bearings. Where used, the rollers 202 may be positioned on opposite sides of the longitudinal axis 70 in the illustrated embodiment. The rollers 202 are engageable with the cam surfaces 186 on the respective jaws 170 to exert a closing force on the jaws 170 when the clamping tool 50 performs a clamping operation. Because the axially-fixed output shaft 114 (which is directly coupled to the transmission 134) is in direct threaded engagement with the roller carriage 190, the length of the drive assembly 102 can be minimized, improving the usability of the clamping tool 50 in tight spaces.

The drive assembly 102, including the transmission 110 and threaded output shaft 114, advantageously provide a reliable and inexpensive means for converting torque from the motor 106 into an axial pressing force exerted by the roller carriage 190. For example, the drive assembly 102 may be simpler and less costly than hydraulic systems, which require pumps, seals, hydraulic fluid reservoirs, and/or the like.

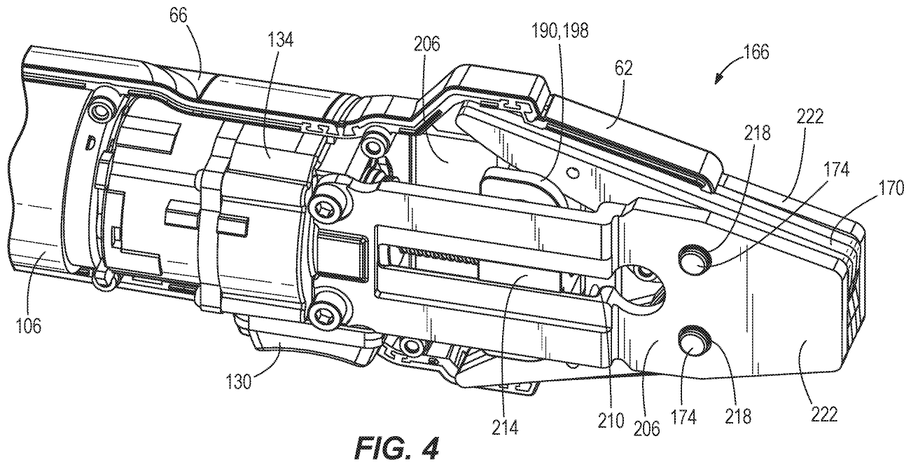

With reference to FIG. 4, the illustrated clamping tool 50 includes a pair of guide plates 206 coupled to and extending from the gear case 134. In the illustrated embodiment, the plates 206 are coupled to the gear case 134 by fasteners (e.g., cap screws); however, the plates 206 may alternatively be welded to the gear case 134 or coupled to the gear case 134 in other ways. Each of the guide plates 206 may include an elongated slot 210 that receives a projecting portion 214 on the main body 198 of the roller carriage 190. The projecting portions 214 are slidable along the respective slots 210 during operation of the clamping tool 50 to stabilize and guide movement of the roller carriage 190. In addition, portions of the main body 198 adjacent the projecting portions 214 may engage an interior surface of the respective guide plates 206. In such embodiments, the main body 198 of the roller carriage 190 may slide along the interior surfaces of the guide plates 206 to further stabilize the roller carriage 190 against lateral movement.

The guide plates 206 also include openings 218 that receive the pivot pins 174 of the jaws 170. In this way, the jaws 170 may pivot respective to the guide plates 206 and/or be pivotally coupled thereto. The guide plates 206 thus act as structural members that interconnect the gear case 134 and the working assembly 166. In addition, the jaws 170 may be sandwiched between tapered end portions 222 of the guide plates 206, which prevents lateral deflection of the jaws 170.

Referring to FIG. 5, in the illustrated embodiment, the clamping tool 50 includes a first position sensor 230 (e.g., a Hall-effect sensor) supported within the head portion 62. For example, in some embodiments, the first position sensor 230 may be provided on a circuit board coupled to one of the guide plates 206. The first position sensor 230 may be configured to detect a position of the roller carriage 190 (e.g., by way of one or more magnets positioned therein) to determine when the roller carriage 190 reaches its fully extended position, corresponding with the closed position of the jaws 170. The one or more magnets may be embedded within the main body 198 of the roller carriage 190 or coupled to an exterior of the roller carriage 190 (e.g., on one or both of the projection portions 214). In some embodiments, the first position sensor 230 may additionally or alternatively be configured to detect a position of the roller carriage 190 to determine when the roller carriage 190 reaches its fully retracted position, corresponding with the open position of the jaws 170. In some embodiments, multiple position sensors 230 may be provided. In addition, the first position sensor 230 may include other types of position sensors, such as one or more limit switches.

In operation of the clamping tool 50, a user may position the clamping tips 178 of the jaws 170 over the tab 26 and/or another portion of a clamp ring 10 (FIG. 1A). The user may activate or engage the switch 130 (e.g., via depressing the switch, rotating the switch, and/or the like) to provide power from the battery 74 to the motor 106, which rotates the motor shaft 118 (FIG. 5). The motor shaft 118 may actuate (e.g., drive) the transmission 110, and the transmission 110 may drive the output shaft 114. When the output shaft 114 rotates, the engagement between the threaded portion 150 of the axially-fixed output shaft 114 and the threaded bore 194 of the roller carriage 190 may cause the roller carriage 190 to advance along the longitudinal axis 70 toward the working assembly 166 (e.g., towards the right in FIG. 5).

As the roller carriage 190 advances, the rollers 202 are configured to bear against the cam surfaces 186 on the jaws 170, forcing the jaws 170 toward the closed position (FIG. 6). The axial reaction force exerted back on the output shaft 114 is born by the thrust bearing 158, which prevents the output shaft 114 from binding. The roller carriage 190 continues to advance until the jaws 170 reach the closed position (FIG. 6), as may be indicated by the first position sensor 230 sensing the magnetic field of the magnets on the roller carriage 190. In this way, the clamp fitting 10 is properly compressed (FIG. 1B).

When the clamping operation is complete, the motor 106 may reverse direction and retract the roller carriage 190. In the illustrated embodiment, the clamping tool 50 is controlled such that the motor 106 automatically reverses direction when the jaws 170 reach the closed position, as indicated by the first position sensor 230. When the motor 106 reverses direction, the first position sensor 230 or a second position sensor (not shown) may detect a position of the roller carriage 190 to indicate when the roller carriage 190 reaches its home position (i.e., a fully-retracted position corresponding with the open position of the jaws 170). In some embodiments, a rotation sensor may additionally or alternatively be provided to determine the position of the roller carriage 190 by counting revolutions of the motor shaft 118 or the output shaft 114. In some embodiments, operation of the clamping tool 50 may be controlled in other ways.

In cases where the jaws 170 are biased open, the cam surfaces 186 of the jaws 170 may remain in contact with the rollers 202. In addition, because clamp fittings 10 require only a relatively small spacing between the clamping tips 178 of the jaws 170 to insert the tab 26 between the jaws 170, the rollers 202 can remain in contact with the jaws 170 when the jaws 170 are in an open position (FIG. 5). In other words, the roller carriage 190 need not retract beyond the arms 182 of the jaws 170. Thus, the length of the clamping tool 50 can be minimized.

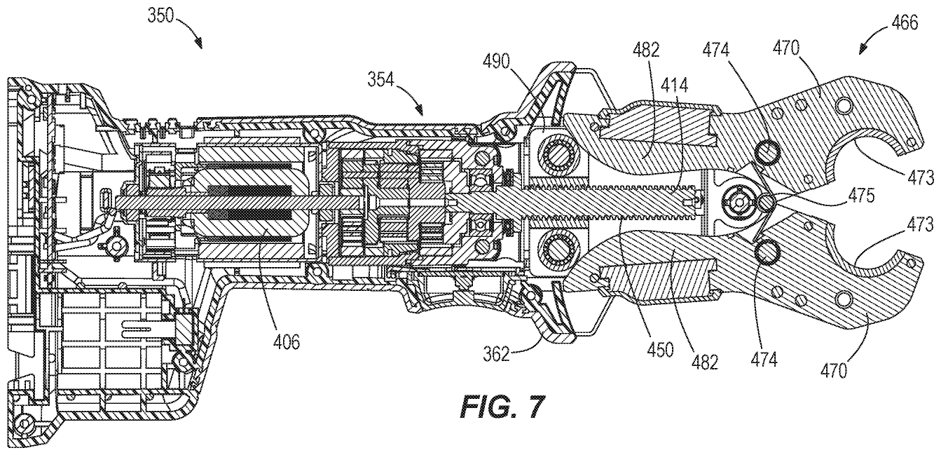

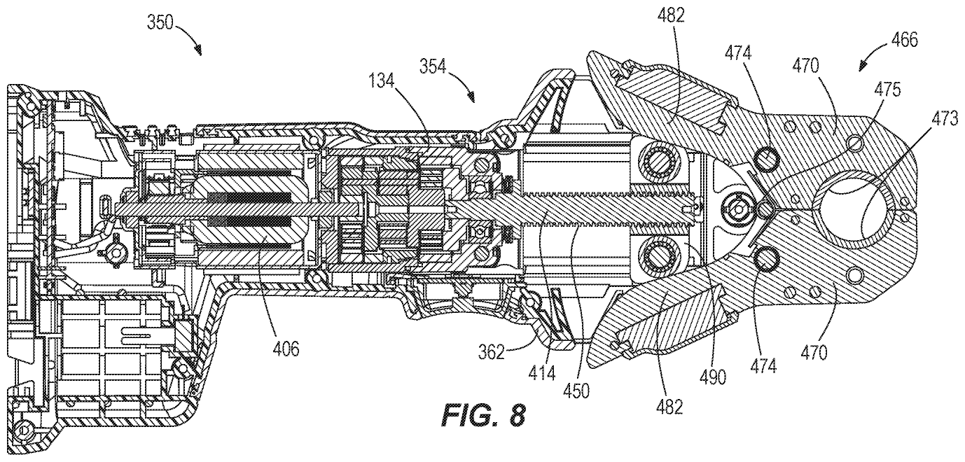

FIGS. 7 and 8 illustrate a pressing tool 350, which is a PEX crimping tool 350 in the illustrated embodiment. The crimping tool 350 is similar to the clamping tool 50 described above with reference to FIGS. 3-6. Accordingly, the following description focuses primarily on differences between the crimping tool 350 and the clamping tool 50. In addition, features and elements of the crimping tool 350 corresponding with features and elements of the clamping tool 50 are given like reference numbers plus ‘300.’

The crimping tool 350 includes a housing 354 with a head portion 362 that supports a working assembly 466. The working assembly 466 includes a pair of jaws 470 that are pivotable about respective parallel pins 474 between an open position (FIG. 7) and a closed position (FIG. 8). Each of the jaws 470 may include a semi-circular crimping die 473 which, in some embodiments, may be removable and replaceable with dies of different nominal diameters. The crimping dies 473 are sized and shaped to engage with crimp rings, such as the crimp ring 30 described above with reference to FIGS. 2A-2C. The jaws 470 are biased toward the closed position by a biasing member 475, which is a torsion spring 475 in the illustrated embodiment. Alternatively, the jaws 370 may be biased toward the open position, or the jaws 470 may not be spring-biased.

In operation of the crimping tool 350, a user may position the crimping dies 473 of the jaws 470 around a crimp ring 30 (FIG. 3A). The crimping tool 350 then operates generally in the same manner as the clamping tool 50 described above with reference to FIGS. 3-6 to move the jaws 470 toward the closed position (FIG. 8) to compress the crimp ring 30. Once the crimping operation is complete, the motor 406 may reverse direction and retract the roller carriage 490. Because the jaws 470 must open wider than the jaws 170 of the clamping tool 50 (in order to insert or remove the crimp ring 30 from between the jaws 470), the threaded portion 450 of the output shaft 414 is longer than that on the clamping tool 50. Accordingly, the roller carriage 490 may retract beyond the arms 482 of the jaws 470, giving the jaws 470 a greater range of motion.

Various features of the subject matter described herein are set forth in the following claims.

What is claimed is:

1. A pressing tool comprising:
a housing;
first and second jaws at least partially disposed in the housing, the first and second jaws being pivotal respective to a portion of the housing;
a motor supported within the housing;
an output shaft driven by the motor, the output shaft including a threaded portion; and
a roller carriage including a threaded bore in which the output shaft is received such that rotation of the output shaft advances or retracts the roller carriage to pivot the first and second jaws.

2. The pressing tool of claim 1, wherein the first and second jaws include a clamping tip configured to compress a PEX clamp ring.

3. The pressing tool of claim 1, wherein the first and second jaws include a crimping die configured to compress a PEX crimp ring.

4. The pressing tool of claim 1, wherein the housing includes a generally cylindrical handle portion defining a longitudinal axis, wherein the handle portion is configured to be gripped by a user during operation of the pressing tool, and wherein the output shaft extends coaxial with the longitudinal axis.

5. The pressing tool of claim 4, wherein the housing includes a battery support portion adjacent the handle portion, wherein the pressing tool further comprises a battery removably coupled to the battery support portion to provide power to the motor wherein the battery support portion includes a receptacle, and wherein the battery includes a stem insertable into the receptacle along a battery axis parallel to the longitudinal axis.

6. The pressing tool of claim 1, wherein the threaded portion includes an Acme thread form.

7. The pressing tool of claim 4, further comprising a transmission coupled between the motor and the output shaft, and a gear case in which the transmission is at least partially disposed.

8. The pressing tool of claim 7, wherein the gear case is disposed within the handle portion of the housing.

9. The pressing tool of claim 7, wherein the output shaft is axially fixed relative to the transmission.

10. A pressing tool comprising:
a housing;
first and second jaws extending from the housing, the first and second jaws being pivotal respective to a portion of the housing;
a motor supported within the housing;
a transmission coupled to the motor, the transmission at least partially disposed within a gear case;
an output shaft coupled to the transmission, the output shaft supported within the housing for rotation about a longitudinal axis, wherein the output shaft is axially fixed relative to the gear case; and
a roller carriage in direct threaded engagement with the output shaft such that rotation of the output shaft advances or retracts the roller carriage to pivot the jaws.

11. The pressing tool of claim 10, wherein the first and second jaws includes one of a clamping tip or a crimping die.

12. The pressing tool of claim 10, wherein one or more magnets are disposed in the roller carriage.

13. The pressing tool of claim 10 further comprising a microcontroller configured to control operation of the motor.

14. A clamping tool, comprising:
a housing;
first and second jaws extending from a portion of the housing, the first and second jaws including an arm, a cam surface on an inner side of the arm, and a clamping tip, wherein the first and second jaws are pivotable between a closed position and an open position for compressing a clamp ring;
a motor supported within the housing;
an output shaft driven by the motor; and
a roller carriage supporting first and second rollers, the roller carriage being coupled to the output shaft such that rotation of the output shaft in a first direction advances the roller carriage to move the jaws toward the closed position, and rotation of the output shaft in a second direction retracts the roller carriage, allowing the jaws to move toward the open position,
wherein the first and second rollers engage the respective cam surfaces of the first and second jaws when in the open position.

15. The clamping tool of claim 14, wherein the roller carriage is in direct threaded engagement with the output shaft.

16. The clamping tool of claim 14, wherein the housing includes a handle portion defining a longitudinal axis and a battery support portion adjacent the handle portion, the clamping tool further comprising a battery removably coupled to the battery support portion to provide power to the motor.

17. The clamping tool of claim 16, wherein the battery support portion includes a receptacle, and wherein the battery includes a stem insertable into the receptacle along a battery axis parallel to the longitudinal axis.

18. The clamping tool of claim 16, further comprising a transmission coupled between the motor and the output shaft, and a gear case in which the transmission is at least partially disposed.

19. The clamping tool of claim 18, wherein the gear case is disposed within the handle portion of the housing.

20. The pressing tool of claim 18, wherein the output shaft is axially fixed relative to the transmission.
